(19) United States
(12) Patent Application Publication
(10) Pub. No.: US 2017/0052517 A1
(43) Pub. Date: Feb. 23, 2017

(54) Desk Adjusting Method and Desk

(71) Applicant: Wistron Corporation, New Taipei City (TW)

(72) Inventors: Meng-Ru Tsai, New Taipei City (TW); Tze-Wen Lin, New Taipei City (TW)

(21) Appl. No.: 15/043,606

(22) Filed: Feb. 14, 2016

(30) Foreign Application Priority Data
Aug. 19, 2015 (TW) 104126913

(51) Int. Cl. G05B 19/042; A47B 9/00; A47B 13/08

(52) U.S. Cl. CPC G05B 19/042; A47B 13/081; A47B 9/00; G05B 2219/25379

(57) ABSTRACT

A desk adjusting method for a desk is disclosed. The desk includes a desktop adjusting module, an input module and a sensing module. The adjusting method includes the input module receiving an identity information, or the sensing module generating a body information; and adjusting a height of the adjustable desk according to the identity information or the body information.

### BACKGROUND OF THE INVENTION

1. Field of the Invention

The present invention relates to a desk adjusting method and a desk, and more particularly, to a desk adjusting method and a desk capable of adjusting the status of the desk suitable for the user and his/her body type.

2. Description of the Prior Art

According to investigation, children usually have problems brought by ill posture during the learning process. For example, a child may lie on the desk when reading or writing, which causes myopia of the child being more serious. In addition, ill posture of the child may cause scoliosis. The prior art already develops an adjustable desk such that a height of the desk is adjustable. However, a height of a particular child increases, and a height of the desk for the particular child should be changed as well. Therefore, to be suitable for the growing child, the height of the desk should be adjusted accordingly, which causes inconvenience on usage of the adjustable desk. From another perspective, since heights of the desk required for different children are different, when different children use the same adjustable desk, the height of the adjustable desk has to be adjusted back and forth, causing another inconvenience on usage of the adjustable desk. Therefore, it is necessary to improve the prior art.

### SUMMARY OF THE INVENTION

It is therefore a primary objective of the present invention to provide a desk adjusting method and a desk capable of adjusting the status of the desk suitable for the user and his/her body type, to improve over disadvantages of the prior art.

An embodiment of the present invention discloses a desk adjusting method, utilized in a desk, the desk comprising a desktop adjusting module, an input module and a sensing module, the desk adjusting method comprising the input module receiving an identity information, or the sensing module generating a body information; and controlling the desktop adjusting module to adjust a status of a desktop related to a base of the desk according to the identity information or the body information.

An embodiment of the present invention further discloses a desk comprising a desktop; a base; a desktop adjusting module, connecting the desktop and the base, configured to adjust a status of a desktop related to a base of the desk according to a control signal; and a control module comprising an input module, configured to receive an identity information; a sensing module, configured to generate a body information; a storage device, configured to store a desktop status information corresponding to the identity information; a processor, coupled to the input module, the sensing module and the storage device, wherein the processor receives the identity information from the input module or receives the body information from the sensing module, and the processor provides the desktop status information according to the identity information or the body information; and a driving module, coupled to the processor, configured to output the control signal to the desktop adjusting module according to the desktop status information, so as to adjust the status of the desktop related to the base of the desk.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of functional blocks of a desk according to an embodiment of the present invention.

FIG. 2A is a side view of the desk shown in FIG. 1.

FIG. 2B is a top view of the desk shown in FIG. 1.

FIG. 3 is a schematic diagram of an adjusting process according to an embodiment of the present invention.

FIG. 4 is a schematic diagram of an adjusting process according to an embodiment of the present invention.

FIG. 5 is a schematic diagram of an adjusting process according to an embodiment of the present invention.

FIG. 6 is a schematic diagram of a side view of a desk according to an embodiment of the present invention.

FIG. 7 is a schematic diagram of an adjusting process according to an embodiment of the present invention.

FIG. 8 is a schematic diagram of a control module according to an embodiment of the present invention.

FIG. 9 is a schematic diagram of a side view of a desk according to an embodiment of the present invention.

FIG. 10 is a schematic diagram of an adjusting process according to an embodiment of the present invention.

FIG. 11 is a schematic diagram of an adjusting process according to an embodiment of the present invention.

FIG. 12 is a schematic diagram of an adjusting process according to an embodiment of the present invention.

### DETAILED DESCRIPTION

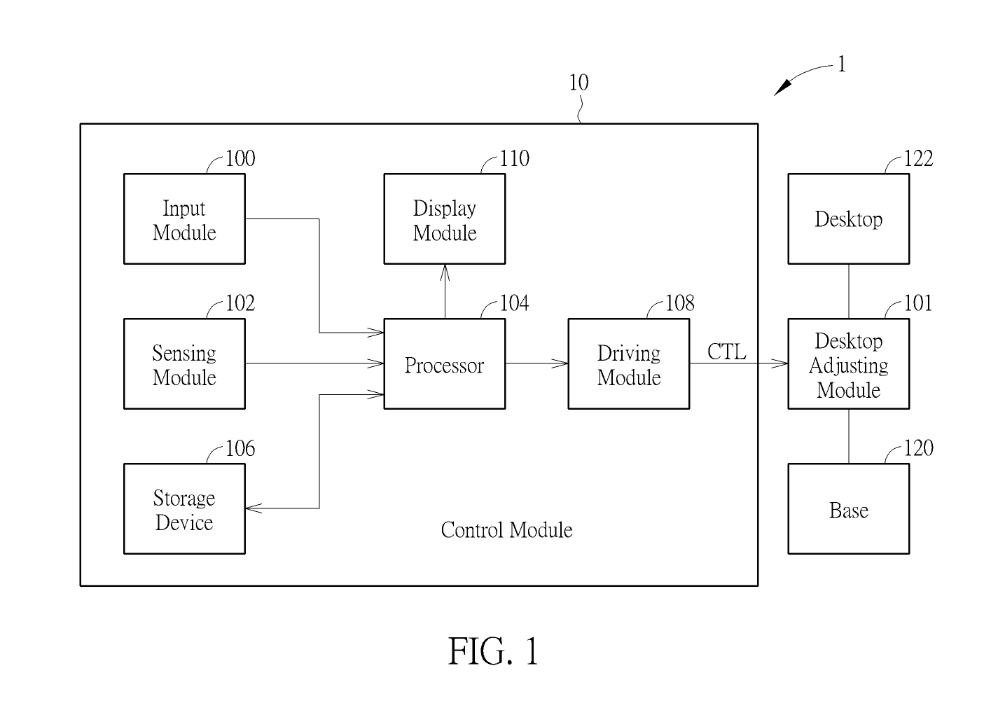

FIG. 1 is a schematic diagram of functional blocks of a desk 1 according to an embodiment of the present invention. The desk 1 comprises a desktop 122, a base 120, a desktop adjusting module 101 and a control module 10. The desktop adjusting module 101 is connected to the desktop 122 and the base 120, configured to adjust a status of the desktop 122 related to the base 120, e.g., a height or an angle of the desktop 122 related to the base 120 according to a control signal CTL. The control module 10 is configured to generate the control signal CTL. The control module 10 comprises an input module 100, a sensing module 102, a processor 104, a storage device 106, a driving module 108 and a display module 110. The input module 100 may comprise input devices, such as buttons, a fingerprint idenficator, etc., configured to receive an identity information ID inputted by a user. The display module 110 is configured to display information inputted by the user. Moreover, the identity information ID is to distinguish different users, and the identity information ID may be a fingerprint information of the user. The sensing module 102 is a distance sensing device, which may sense distance using infrared-ray or ultrasound. The sensing module 102 is configured to sense a first distance information D1 between the desktop 122 of the desk 1 and a knee of a user and generate a body information BD_1 including the first distance information D1. The storage device 106 is configured to store a desktop status information corresponding to a spedicifc user. The desktop status information may be a height information or an inclination information. The processor 104 is coupled to the input module 100, the sensing module 102 and the storage device 106. The processor 104 is configured to receive the identity information ID or the body information BD_1, and provides a height information HI to the driving module 108 according to the identity information ID or the body information BD_1. The driving module 108 is coupled to the processor 104, configured to output the control signal CTL to the desktop adjusting module 101 according to the height information HI.

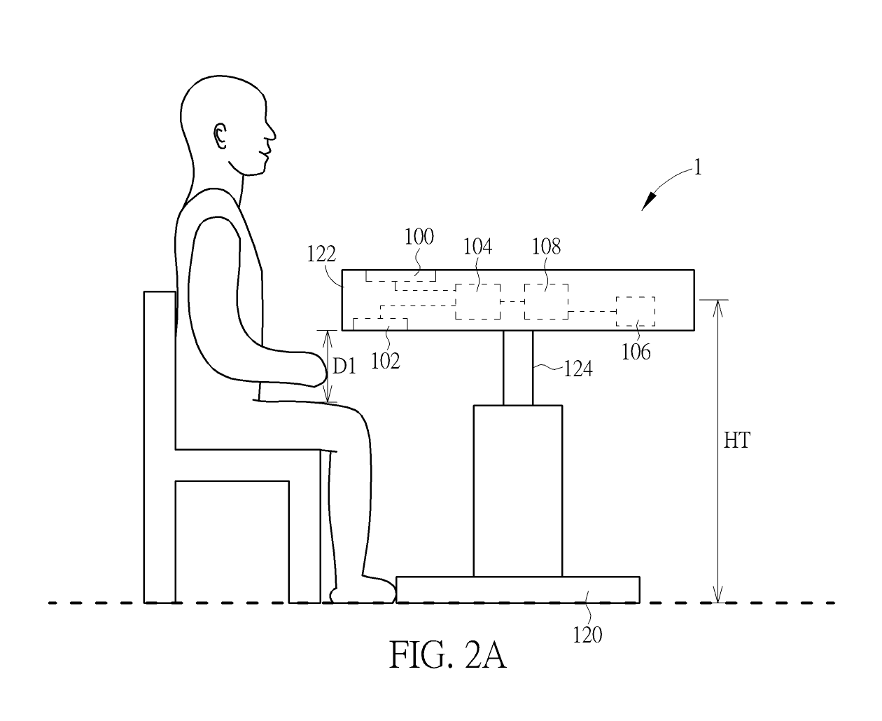

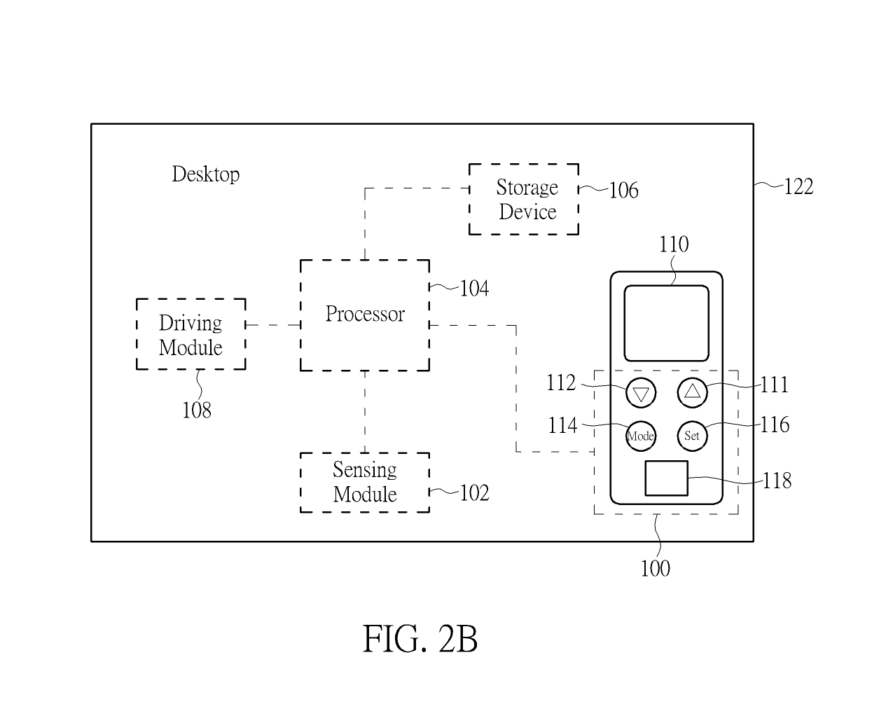

In detail, FIG. 2A illustrates a side view of the desk 1, and FIG. 2B illustrates a top view of the desk 1. In the current embodiment, the desktop adjusting module 101 of the desk 1 adjusts a height HT of the desktop 122 related to the base 120 using a first extensible pillar 124. The first extensible pillar 124 may be extended or shortened according to the control signal CTL, so as to adjust the height HT of the desktop 122 related to the base 120. The control module 10 may control the height HT of the desk 1 by outputting the control signal CTL to the first extensible pillar 124 (i.e., the driving module 108 adjusts the height HT of the desk 1). The sensing module 102 may be disposed under the desktop 122, configured to sense the first distance information D1 of the desktop 122 related to the knee of the user. Therefore, the sensing module 102 may generate the body information BD_1 including the first distance information D1.

In addition, as FIG. 2B shows, the input module 100 and the display module 110 may be disposed on the desktop 122, such that the user may input the identity information ID and a mode information MD conveniently. Moreover, the input module 100 may comprises an up button 111, a down button 112, a mode selection button 114, a set button 116 and a fingerprint identificator 118. The user may input the identity information ID via the fingerprint identificator 118 (the identity information ID is a fingerprint information of the user), and input the mode information MD using the up button 111, the down button 112, the mode selection button 114 and the set button 116.

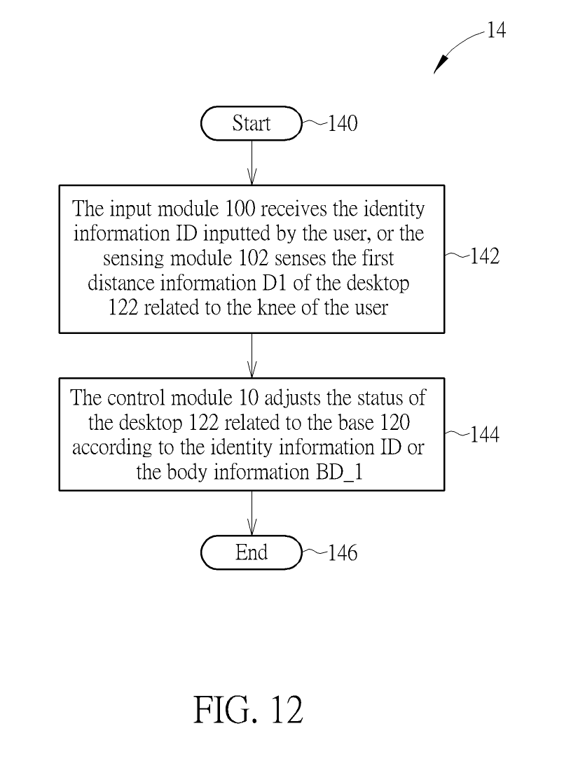

In short, the control module 10 may receive the identity information ID via the input module 100 or generate the body information BD_1 by the sensing module 102, and adjust the height HT of the desk 1 according to the identity information ID or the body information BD_1. Please refer to FIG. 12 to see detailed operations of the control module 10. FIG. 12 is a schematic diagram of an adjusting process 14 according to an embodiment of the present invention. The adjusting process 14 may be executed by the control module 10. The adjusting process 14 includes the following steps:

Step 140: Start.

Step 142: The input module 100 receives the identity information ID inputted by the user, or the sensing module 102 senses the first distance information D1 of the desktop 122 related to the knee of the user.

Step 144: The control module 10 adjusts the status of the desktop 122 related to the base 120 according to the identity information ID or the body information BD_1.

Step 146: End.

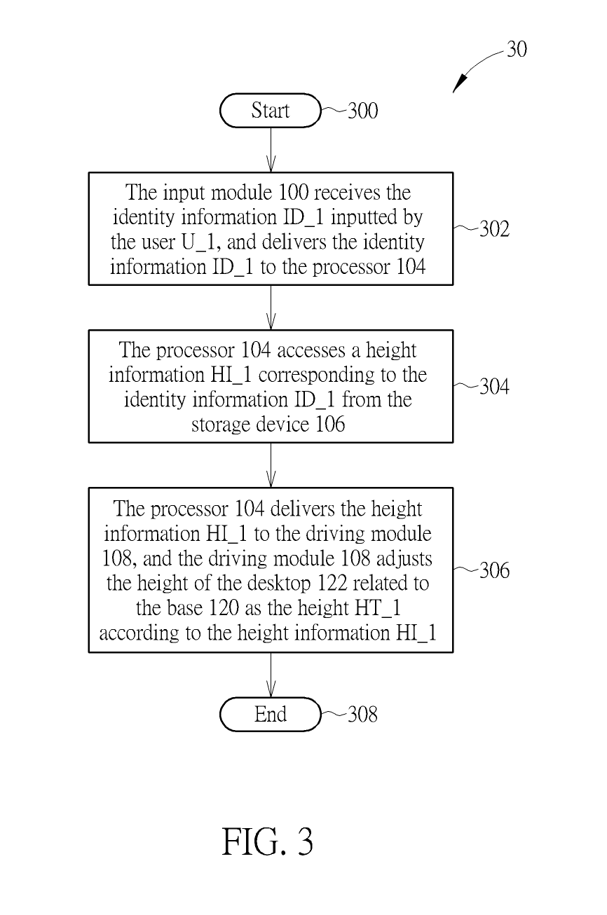

According to the adjusting process 14, for a registered user U_1, the control module 10 may adjust the desk 1 to a height HT_1, where the height HT_1 is specified and pre-defined by the registered user U_1. Specifically, the control module 10 may store a height information HI_1 set by the user U_1 in the storage device 106 in advance. After the control module 10 receives an identity information ID_1 corresponding to the user U_1, the control module 10 may adjust the desk 1 to the height HT_1 according to the identity information ID_1. Please refer to FIG. 3, which is a schematic diagram of an adjusting process 30 according to an embodiment of the present invention. The adjusting process 30 may be executed by the control module 10. The adjusting process 30 includes the following steps:

Step 300: Start.

Step 302: The input module 100 receives the identity information ID_1 inputted by the user U_1, and delivers the identity information ID_1 to the processor 104.

Step 304: The processor 104 accesses a height information HI_1 corresponding to the identity information ID_1 from the storage device 106.

Step 306: The processor 104 delivers the height information HI_1 to the driving module 108, and the driving module 108 adjusts the height of the desktop 122 related to the base 120 as the height HT_1 according to the height information HI_1.

Step 308: End.

The adjusting process 30 is suitable for the registered user U_1. That is, when the user U_1 sits at the desk 1, the user U_1 may input the identity information ID_1 via the input module 100. After the control module 10 receives the identity information ID_1 (Step 302), the processor 104 may access the height information HI_1 (Step 304) specified by the user U_1 from the storage device 106, and send the height information HI_I to the driving module 108. In Step 306, the driving module 108 may control the first extensible pillar 124 according to the height information HI_1, such that a height of the desk 1 is adjusted to be the height HT_1.

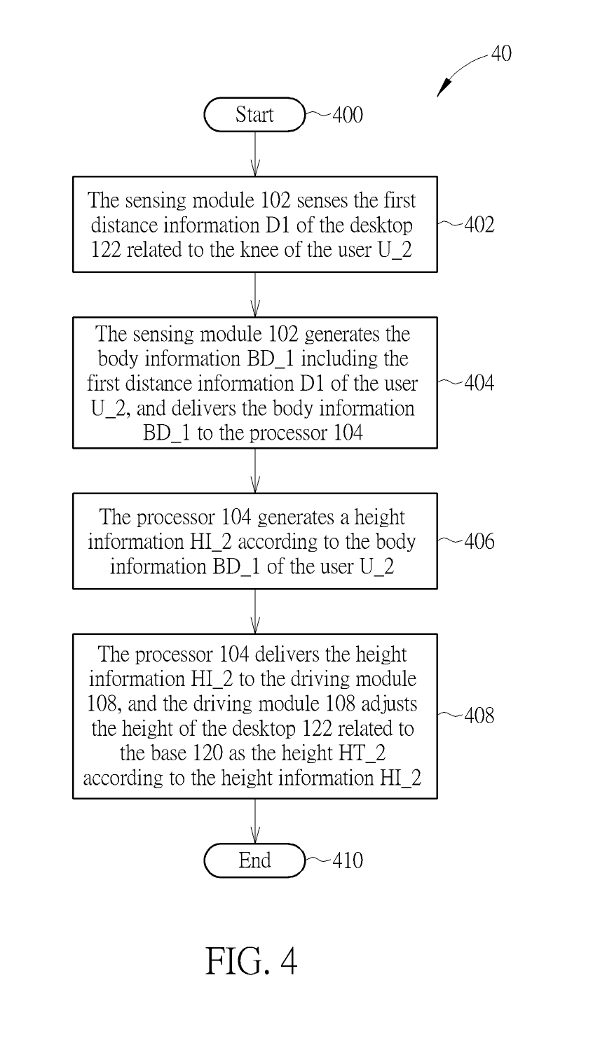

On the other hand, for an unregistered user U_2, the control module 10 may obtain the body information BD_1 of the user U_2 through the sensing module 102, and adjust the height of the desk 1 to be suitable for the user U_2. Please refer to FIG. 4, which is a schematic diagram of an adjusting process 40 according to an embodiment of the present invention. The adjusting process 40 may be executed by the control module 10. The adjusting process 40 includes the following:

Step 400: Start.

Step 402: The sensing module 102 senses the first distance information D1 of the desktop 122 related to the knee of the user U_2.

Step 404: The sensing module 102 generates the body information BD_1 including the first distance information D1 of the user U_2, and delivers the body information BD_1 to the processor 104.

Step 406: The processor 104 generates a height information HI_2 according to the body information BD_1 of the user U_2.

Step 408: The processor 104 delivers the height information HI_2 to the driving module 108, and the driving module 108 adjusts the height of the desktop 122 related to the base 120 as the height HT_2 according to the height information HI_2.

Step 410: End.

The adjusting process 40 is suitable for the unregistered user U_2. That is, the storage device 106 does not store any height information corresponding to the unregistered user U_2. When the user U_2 sits at the desk 1, the control module 10 senses the distance between the desktop 122 and the knee of the user U_2 via the sensing module 102 disposed under the desktop 122, and adjusts the height of the desktop 122 as the height HT_2 suitable for the user U_2 accordingly. Specifically, after the sensing module 102 senses the first distance information D1 of the desktop 122 related to the knee of the user U_2, and delivers the body information BD_1 including the first distance information D1 to the processor 104 (Steps 402-404) , in Step 406, the processor 104 may generate the height information HI_2 according to the body information BD_1 of the user U_2, such that the desktop 122 may be a first specific distance higher that the knee of the user U_2. In an embodiment, the first specific distance may be 10-15 centimeters, and the height information HI_2 includes height information suitable for the user U_2. In Step 408, the processor 104 sends the height information HI_2 to the driving module 108, and the driving module 108 may control the first extensible pillar 124 according to the height information HI_2, such that the height of the desk 1 is adjusted to be the height HT_2. Therefore, according to the adjusting process 40, the control module 10 may adjust the height of the desk 1 to be the height HT_2, suitable for the user U_2.

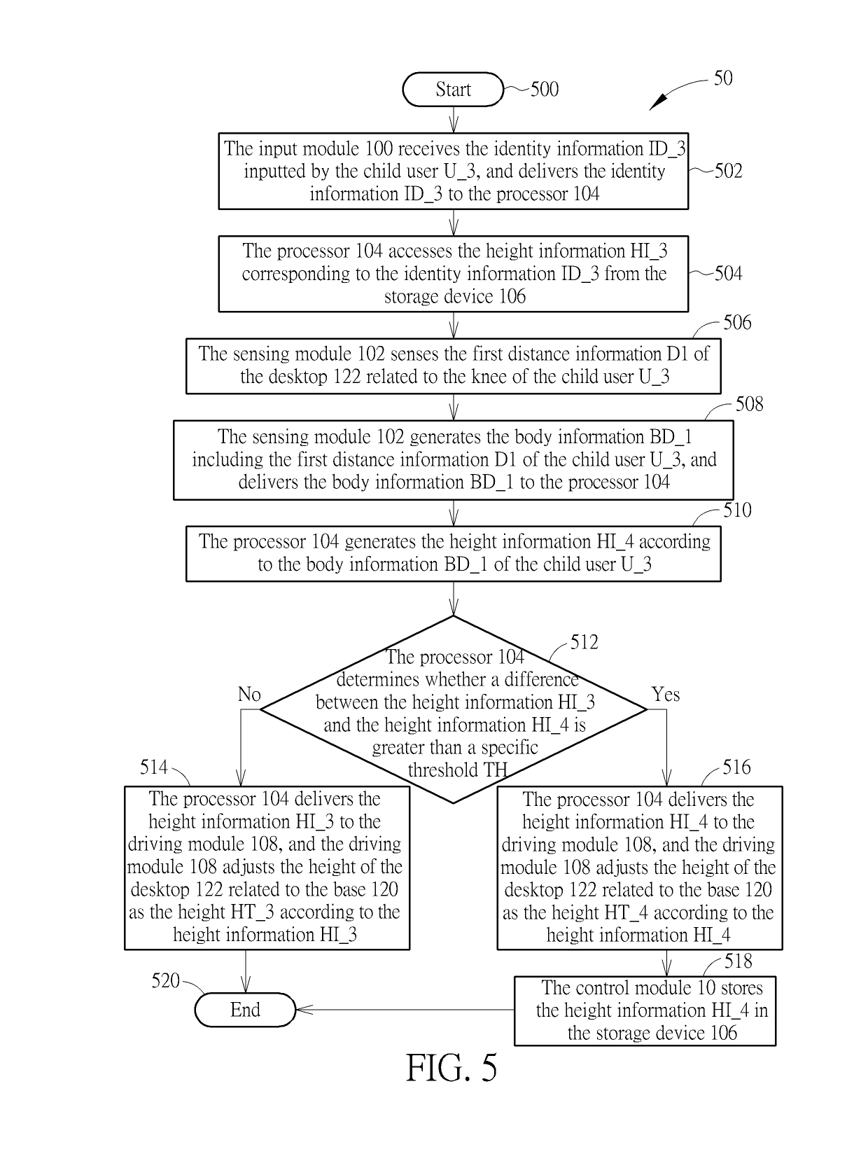

In addition, the control module 10 may be applied to children. Since heights of the children are growing, the control module 10 may sense the body information BD_1 of a child user U_3 at any time via the sensing module 102 and adjust the height of the desk 1 to be a height HT_3 suitable for the child user U_3. Specifically, a height information HI_3 suitable for the child user U_3 may be stored in the storage device 106 in advance. Meanwhile, the control module 10 may sense the body information BD_1 of the child user U_3 at any time via the sensing module 102, and generate a height information HI_4 corresponding to the child user U_3 according to the body information BD_1 of the child user U_3. Hence, the desktop adjusting module 101 may adjust the height of the desk 1 to be a height HT_3 or a height HT_4 suitable for the child user U_3 according to the height information HI_3 or the height information HI_4. Please refer to FIG. 5, which is a schematic diagram of an adjusting process 50 according to an embodiment of the present invention. The adjusting process 50 may be executed by the control module 10. The adjusting process 50 includes the following steps:

Step 500: Start.

Step 502: The input module 100 receives the identity information ID_3 inputted by the child user U_3, and delivers the identity information ID_3 to the processor 104.

Step 504: The processor 104 accesses the height information HI_3 corresponding to the identity information ID_3 from the storage device 106.

Step 506: The sensing module 102 senses the first distance information D1 of the desktop 122 related to the knee of the child user U_3.

Step 508: The sensing module 102 generates the body information BD_1 including the first distance information D1 of the child user U_3, and delivers the body information BD_1 to the processor 104.

Step 510: The processor 104 generates the height information HI_4 according to the body information BD_1 of the child user U_3.

Step 512: The processor 104 determines whether a difference between the height information HI_3 and the height information HI_4 is greater than a specific threshold TH. If yes, go to Step 516; otherwise, go to Step 514.

Step 514: The processor 104 delivers the height information HI_3 to the driving module 108, and the driving module 108 adjusts the height of the desktop 122 related to the base 120 as the height HT_3 according to the height information HI_3.

Step 516: The processor 104 delivers the height information HI_4 to the driving module 108, and the driving module 108 adjusts the height of the desktop 122 related to the base 120 as the height HT_4 according to the height information HI_4.

Step 518: The control module 10 stores the height information HI_4 in the storage device 106.

Step 520: End.

The adjusting process 50 is suitable for the growing child user U_3. Specifically, when the child user U_3 sits at the desk 1, the child user U_3 may input the identity information ID 3 of the child user U_3 via the input module 100. In Step 502-504, after the input module 100 receives the identity information ID_3, the processor 104 of the control module 10 may access the height information HI_3 from the storage device 106, where the height information HI_3 is the height information stored at a first time T1 in the storage device 106. Meanwhile, in Step 506-510, the control module 10 may sense the body information BD_1 of the child user U_3 at a second time T2 via the sensing module 102, and generate the height information HI_4 suitable for the child user U_3 accordingly.

Notably, in Step 512, the processor 104 determines whether the difference between the height information HI_3 and the height information HI_4 is greater than the specific threshold TH. If the difference between the height information HI_3 and the height information HI_4 is smaller than the specific threshold TH, it represents that the incremental height of the child user U_3 does not change significantly during a time period between the first time T1 and the second time T2. Therefore, there is no need for the control module 10 to update the height HT_3 of the child user U_3. Hence, the control module 10 executes Step 514 to adjust the desk 1 to the height HT_3. On the other hand, if the difference between the height information HI_3 and the height information HI_4 is greater than the specific threshold TH, it represents that that the incremental height of the child user U_3 changes significantly during the time period between the first time T1 and the second time T2. Hence, the control module 10 executes Step 516 to adjust the desk 1 to the height HT_4 according to the height information HI_4, and executes Step 518 to store the height information HI_4 in the storage device 106, so as to update the height of the child user U_3 as the height HT_4. Details of Steps 514, 516 are the same as which of Step 306 (or Step 408), which are not narrated herein.

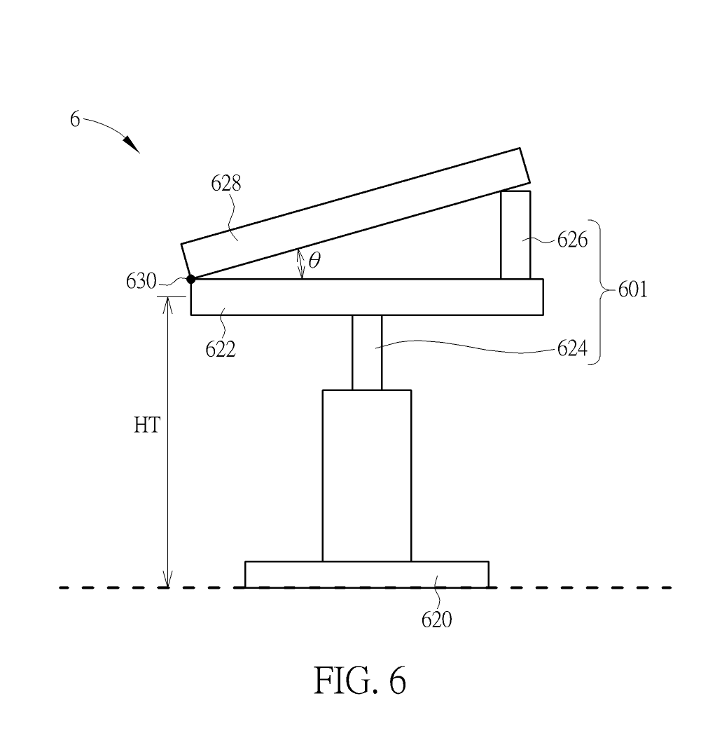

In addition, the control module 10 is able to adjust an inclination of the desk. FIG. 6 is a schematic diagram of a side view of a desk 6 according to an embodiment of the present invention. The desk 6 comprises a base 620, a horizontal platform 622, a tiltable desktop 628, a pivot unit 630 and a desktop adjusting module 601. In the current embodiment, the desktop adjusting module 601 comprises a first extensible pillar 624 and a second extensible pillar 626. The horizontal platform 622 is parallel to the base 620. The first extensible pillar 624 is configured to adjust the height HT of the desk 6 (the distance of the horizontal platform 622 related to the ground). The second extensible pillar 626 is disposed on the horizontal platform 622, configured to adjust an inclination θ of the desk 6. The inclination θ is an angle between the tiltable desktop 628 and the horizontal platform 622 (or the base 620). The pivot unit 630 is connected between the horizontal platform 622 and the tiltable desktop 628. When the second extensible pillar 626 is controlled to extend, the pivot unit 630 may bring an increment of the angle between the tiltable desktop 628 and the horizontal platform 622, such that the inclination θ of the desk 6 is increased. The control module 10 may be disposed on the desk 6, and the first extensible pillar 624 and the second extensible pillar 626 may be controlled by the driving module 108. Thereby, the control module 10 adjusts the height of the desk 6 by controlling the first extensible pillar 624, and adjusts the inclination θ of the desk 6 by controlling the second extensible pillar 626.

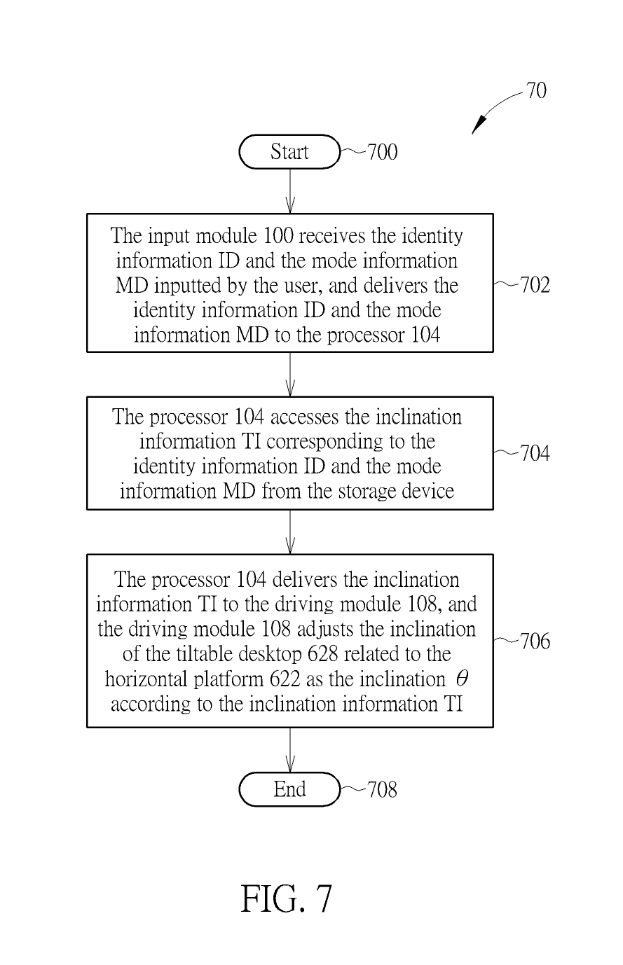

The inclination θ of the desk 6 may be related to different operation modes. For example, when the user does painting or some handicraft work on the desk 6, the desk 6 may be in a first mode with the inclination θ being 0°. When the user reads or writes on the desk 6, the desk 6 may be in a second mode with the inclination θ being greater than 0°. The control module 10 may store the inclination information TI corresponding to different users and different operation modes in the storage device 106 in advance. After the user inputs the mode information MD, the control module 10 may access the inclination information TI corresponding to the mode information MD from the storage device 106. Please refer to FIG. 7, which is a schematic diagram of an adjusting process 70 according to an embodiment of the present invention. The adjusting process 70 may be executed by the control module 10. The adjusting process 70 is utilized for adjusting the inclination θ of the desk 6. The adjusting process 70 includes the following steps:

Step 700: Start.

Step 702: The input module 100 receives the identity information ID and the mode information MD inputted by the user, and delivers the identity information ID and the mode information MD to the processor 104.

Step 704: The processor 104 accesses the inclination information TI corresponding to the identity information ID and the mode information MD from the storage device.

Step 706: The processor 104 delivers the inclination information TI to the driving module 108, and the driving module 108 adjusts the inclination of the tiltable desktop 628 related to the horizontal platform 622 as the inclination θ according to the inclination information TI.

Step 708: End.

According to the adjusting process 70, the control module 10 may adjust the inclination of the desk 6 based on the identity information ID and the mode information MD inputted by the user. When the user sits at the desk 6, the user may input the mode information MD via the input module 100. When the control module 10 receives the identity information ID and the mode information MD (Step 702), the processor 104 may access the inclination information TI stored in the storage device 106 (Step 704), and deliver the inclination information TI to the driving module 108. In Step 706, the driving module 108 may control the second extensible pillar 626 according to the inclination information TI, such that the inclination of the desk 6 is adjusted to be the inclination θ.

As can be seen from the above, the present invention utilizes the input module 100 to receive the identity information ID of users, so as to access the height information HI corresponding to the users. The present invention also utilizes the sensing module 102 to sense the body information BD_1 of the users, so as to adjust the height of the desk according to body types of the users. As for the child user U_3, the present invention may utilize the identity information ID and the body information BD_1 to adjusting the height of the desk suitable for the child user U_3. In addition, the present invention may adjust the inclination of the desk according to the mode information MD.

Notably, the embodiments stated in the above are utilized for illustrating the concept of the present invention. Those skilled in the art may make modifications and alternations accordingly, and not limited herein. For example, the first distance information D1 is not limited to represent the distance between the desktop and the knee of the user. The first distance information D1 may also represent a distance of the desktop related to a seat surface of a chair, which is within the scope of the present invention. In addition, the input module is not limited to be the fingerprint identificator. The input module may be a wireless or wired keyboard, a touch screen, a writing panel, an image scanner, an iris sensor, a voice sensor, a voiceprint identificator, etc. The identity information ID may be a password manually inputted by the user through the wireless or wired keyboard, a specific line pattern or picture drawn by the user through the touch screen or the writing panel, a quick response code (QR code) or a two-dimensional barcode scanned by the user through the image scanner, an iris of the user sensed by the iris sensor, a voice of the user sensed by the voice sensor, a voiceprint of the user identified by the voiceprint identificator, which are not limited herein. In addition, the desktop adjusting module is not limited to use extensible pillars to adjust the status of the desktop. The desktop adjusting module may use toothed wheels or sliding rails to adjust the status of the desktop. In addition, in the adjusting process 70, the inclination θ of the desk 6 is related to the identity information ID and the mode information MD inputted by the user, which is not limited herein. The inclination θ of the desk may be related to the mode information MD inputted by the user only, which is also within the scope of the present invention.

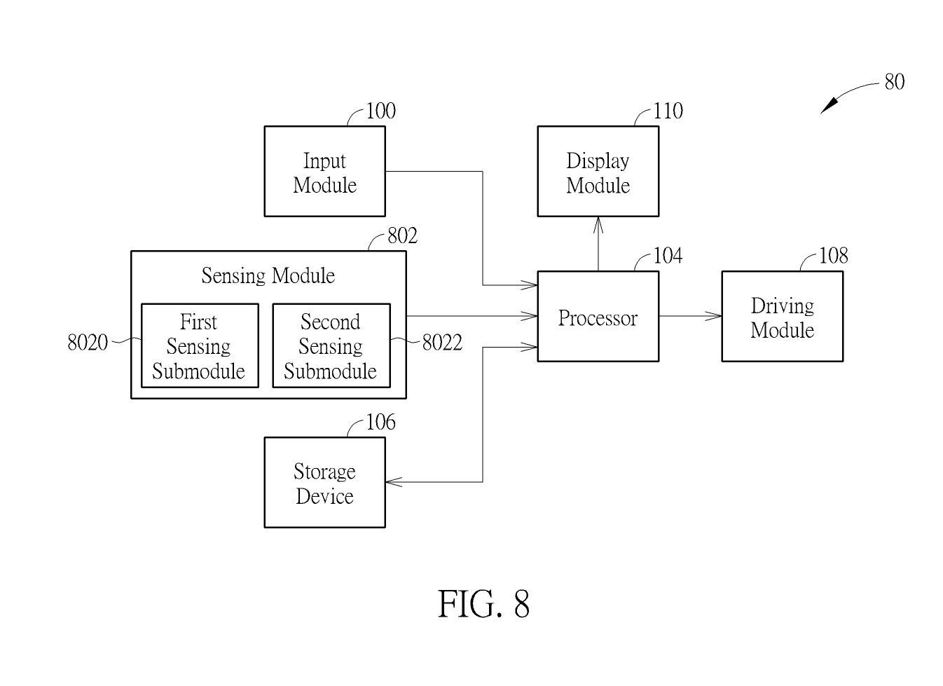

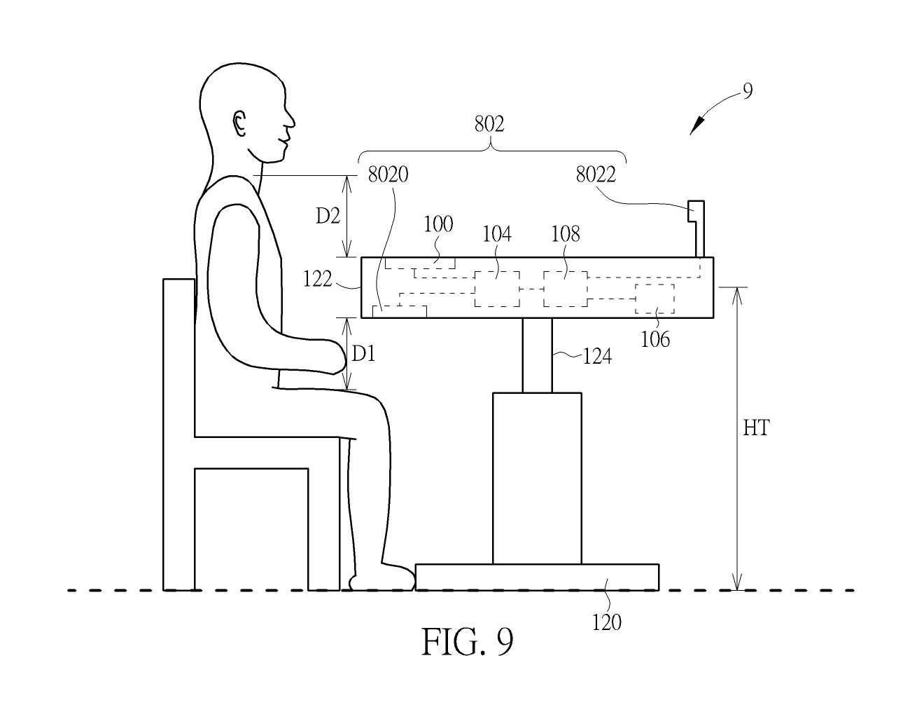

In addition, to compute the height of the desktop suitable for the user accurately, the present invention may further sense a second distance information D2 of the desktop in related to a shoulder of the user, and compute the height of the desktop suitable for the user according to the first distance information D1 and the second distance information D2. Please refer to FIG. 8, which is a schematic diagram of a control module 80 according to an embodiment of the present invention. The control module 80 is similar to the control module 10, and thus, the same components are denoted by the same symbols. The control module 80 comprises a sensing module 802. The sensing module 802 comprises a first sensing submodule 8020 and a second sensing submodule 8022. The first sensing submodule 8020 is a distance sensing device using, for example, infrared-ray or ultrasound, configured to sense the first distance information D1 between the desktop and the knee of the user. The second sensing submodule 8022 is a sensor with functions of distance sensing and image recognition, configured to sense the second distance information D2 of the desktop related to the shoulder of the user. The sensing module 802 generates the body information BD_2 including the first distance information D1 and the second distance information D2 accordingly. Please refer to FIG. 9, which is a schematic diagram of a side view of a desk 9 according to an embodiment of the present invention. The desk 9 is similar to the desk 1, and thus, the same components are denoted by the same symbols. Different from the desk 1, the desk 9 comprises the sensing module 802. Moreover, the first sensing submodule 8020 of the sensing module 802 is disposed under the desktop 122, the second sensing submodule 8022 is disposed on the desktop 122.

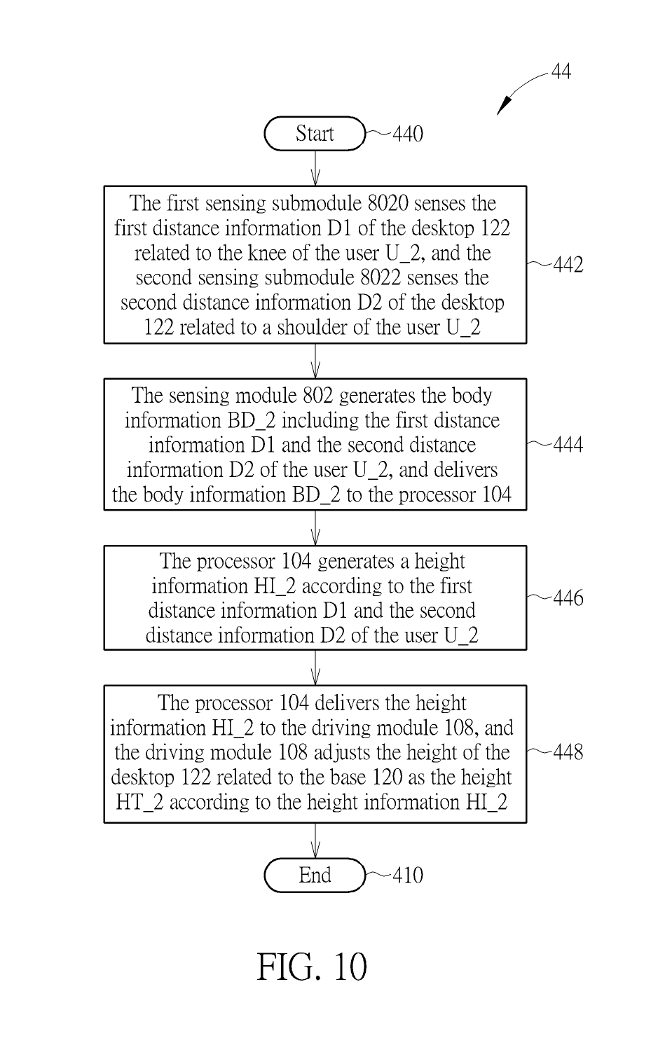

Therefore, for the unregistered user U_2, the control module 80 may obtain the body information BD_2 of the user U_2 via the sensing module 802, and adjust the height of the desk 1 to be suitable for the user U_2. Please refer to FIG. 10, which is a schematic diagram of an adjusting process 44 according to an embodiment of the present invention. The adjusting process 44 may be executed by the control module 80. The adjusting process 44 includes the following steps:

Step 440: Start.

Step 442: The first sensing submodule 8020 senses the first distance information D1 of the desktop 122 related to the knee of the user U_2, and the second sensing submodule 8022 senses the second distance information D2 of the desktop 122 related to a shoulder of the user U_2.

Step 444: The sensing module 802 generates the body information BD_2 including the first distance information D1 and the second distance information D2 of the user U_2, and delivers the body information BD_2 to the processor 104.

Step 446: The processor 104 generates a height information HI_2 according to the first distance information D1 and the second distance information D2 of the user U_2.

Step 448: The processor 104 delivers the height information HI_2 to the driving module 108, and the driving module 108 adjusts the height of the desktop 122 related to the base 120 as the height HT_2 according to the height information HI_2.

Step 450: End.

The adjusting process 44 is similar to the adjusting process 40. Different from the adjusting process 40, the adjusting process 44 exploits the second sensing submodule 8022 to sense the second distance information D2 of the desktop 122 related to the shoulder of the user U_2, and generates the height information HI_2 according to the first distance information D1 and the second distance information D2. Specifically, in Step 446, according to the first distance information D1 and the second distance information D2, the processor 104 may compute a trunk length of the user U_2. According to the trunk length of the user U_2, the processor 104 may generate the height information HI_2, such that the desktop 122 is a second specific distance higher than the knee of the user U_2, where the second specific distance may be related to the trunk length of the user U_2. For example, the second specific distance may be a specific ratio of the trunk length of the user U_2, e.g., the second specific distance may be one third of the trunk length of the user U_2. Hence, the processor 104 may generate the height information HI_2 so as to adjust the desktop 122 to be one third of the trunk length higher than the knee of the user U_2 (i.e., two thirds of the trunk length lower than the shoulder of the user U_2). Details of the adjusting process 44 may be referred to paragraphs in the above, which are not narrated herein.

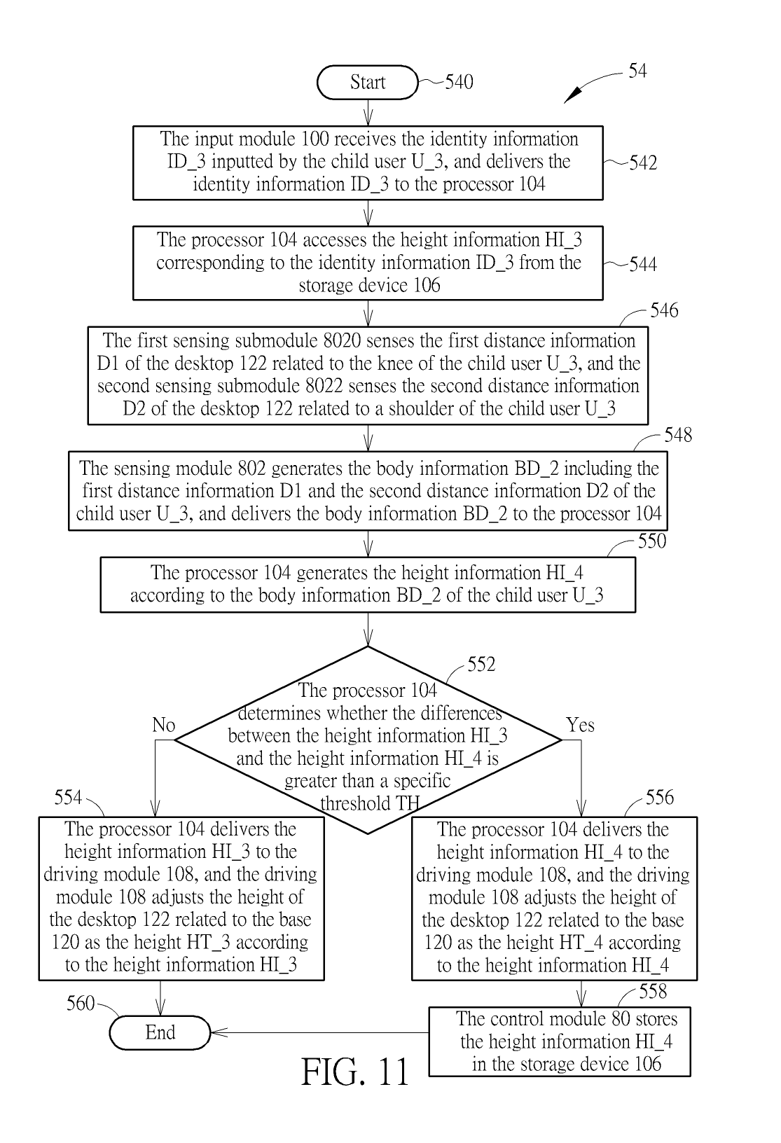

Similarly, the control module 80 may also be applied to the child user U_3. Please refer to FIG. 11 to see detail operations of the control module 80. FIG. 11 is a schematic diagram of an adjusting process 54 according to an embodiment of the present invention. The adjusting process 54 may be executed by the control module 80. The adjusting process 54 includes the following steps:

Step 540: Start.

Step 542: The input module 100 receives the identity information ID_3 inputted by the child user U_3, and delivers the identity information ID_3 to the processor 104.

Step 544: The processor 104 accesses the height information HI_3 corresponding to the identity information ID_3 from the storage device 106.

Step 546: The first sensing submodule 8020 senses the first distance information D1 of the desktop 122 related to the knee of the child user U_3, and the second sensing submodule 8022 senses the second distance information D2 of the desktop 122 related to a shoulder of the child user U_3.

Step 548: The sensing module 802 generates the body information BD_2 including the first distance information D1 and the second distance information D2 of the child user U_3, and delivers the body information BD_2 to the processor 104.

Step 550: The processor 104 generates the height information HI_4 according to the body information BD_2 of the child user U_3.

Step 552: The processor 104 determines whether the differences between the height information HI_3 and the height information HI_4 is greater than a specific threshold TH. If yes, go to Step 556; otherwise, go to Step 554.

Step 554: The processor 104 delivers the height information HI_3 to the driving module 108, and the driving module 108 adjusts the height of the desktop 122 related to the base 120 as the height HT_3 according to the height information HI_3.

Step 556: the processor 104 delivers the height information HI_4 to the driving module 108, and the driving module 108 adjusts the height of the desktop 122 related to the base 120 as the height HT_4 according to the height information HI_4.

Step 558: The control module 80 stores the height information HI_4 in the storage device 106.

Step 560: End.

The adjusting process 54 is similar to the adjusting process 50. Different from the adjusting process 50, the adjusting process 54 exploits the second sensing submodule 8022 to sense the second distance information D2 of the desktop 122 related to the shoulder of the child user U_3, and generate the height information HI_4 according to the first distance information D1 and the second distance information D2. Details of the adjusting process 54 may be referred to paragraph in the above, which are not narrated herein.

In summary, the present invention obtains the identity information of different users via the input module, accesses the height information correspond to the users, and senses the body information of the users via the sensing module. Therefore, the present invention may adjust the height of the desktop suitable for the user and his/her body type. For the child user, the present invention may keep adjusting the height of the desktop suitable for the child user according to the identity information and the body information. In addition, the present invention may adjust the inclination of the desk according to the mode information.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A desk adjusting method, utilized in a desk, the desk comprising a desktop adjusting module, an input module and a sensing module, the desk adjusting method comprising:
the input module receiving an identity information, or the sensing module generating a body information; and
controlling the desktop adjusting module to adjust a status of a desktop related to a base of the desk according to the identity information or the body information.

2. The desk adjusting method of claim 1, wherein the step of controlling the desktop adjusting module to adjust the status of the desktop related to the base of the desk according to the identity information comprises:
obtaining a first height information corresponding to the identity information from a storage device of the desk; and
adjusting a height of the desktop related to the base of the desk according to the first height information.

3. The desk adjusting method of claim 1, wherein the step of the sensing module generating the body information comprises:
the sensing module sensing a first distance information of the desktop of the desk related to a chair surface or a knee of a user;
the sensing module generating the body information comprising the first distance information.

4. The desk adjusting method of claim 3, wherein the step of controlling the desktop adjusting module to adjust the status of the desktop related to the base of the desk according to the body information comprises:
generating a second height information according to the first distance information of the body information; and
adjusting a height of the desktop related to the base of the desk according to the second height information.

5. The desk adjusting method of claim 3, wherein the step of controlling the desktop adjusting module to adjust the status of the desktop related to the base of the desk according to the identity information or the body information comprises:
obtaining a third height information corresponding to the identity information from a storage device of the desk;
generating a fourth height information according to the first distance information of the body information; and
adjusting a height of the desktop related to the base of the desk according to the fourth height information when a difference between the third information and the fourth information is larger than a specific value.

6. The desk adjusting method of claim 5, further comprising:
storing the fourth height information when the difference is larger than the specific value.

7. The desk adjusting method of claim 1, wherein the step of the sensing module generating the body information comprises:
the sensing module sensing a first distance information of the desktop of the desk related to a chair surface or a knee of a user and sensing a second distance information of the desktop of the desk related to a shoulder of the user;
the sensing module generating the body information comprising the first distance information and the second distance information.

8. The desk adjusting method of claim 7, wherein the step of controlling the desktop adjusting module to adjust the status of the desktop related to the base of the desk according to the body information comprises:
generating a second height information according to the first distance information and the second distance information of the body information; and
adjusting a height of the desktop related to the base of the desk according to the second height information.

9. The desk adjusting method of claim 7, wherein the step of controlling the desktop adjusting module to adjust the status of the desktop related to the base of the desk according to the identity information or the body information comprises:
obtaining a third height information corresponding to the identity information from a storage device of the desk;
generating a fourth height information according to the first distance information or the second distance information of the body information; and
adjusting a height of the desktop related to the base of the desk according to the fourth height information when a difference between the third information and the fourth information is larger than a specific value.

10. The desk adjusting method of claim 9, further comprising:
storing the fourth height information when the difference is larger than the specific value.

11. The desk adjusting method of claim 1, further comprising:
the input module receiving a mode information; and
adjusting an inclination of the desktop related to the base of the desk according to the mode information.

12. The desk adjusting method of claim 11, further comprising:
adjusting the inclination of the desktop related to the base of the desk according to the mode information and the identity information.

13. A desk, comprising:
a desktop;
a base;
a desktop adjusting module, connecting the desktop and the base, configured to adjust a status of a desktop related to a base of the desk according to a control signal; and
a control module, comprising:
an input module, configured to receive an identity information;
a sensing module, configured to generate a body information;
a storage device, configured to store a desktop status information corresponding to the identity information;
a processor, coupled to the input module, the sensing module and the storage device, wherein the processor receives the identity information from the input module or receives the body information from the sensing module, and the processor provides the desktop status information according to the identity information or the body information; and
a driving module, coupled to the processor, configured to output the control signal to the desktop adjusting module according to the desktop status information, so as to adjust the status of the desktop related to the base of the desk.

14. The desk of claim 13, wherein after the processor obtains the identity information from the input module, the processor obtains a first height information corresponding to the identity information from the storage device of the desk, and the driving module adjusts a height of the desktop related to the base of the desk according to the first height information.

15. The desk of claim 13, wherein the sensing module senses a first distance information of the desktop of the desk related to a chair surface or a knee of a user, and generates the body information comprising the first distance information.

16. The desk of claim 15, wherein the processor generates a second height information according to the first distance information of the body information, and the driving module adjusting a height of the desktop related to the base of the desk according to the second height information.

17. The desk of claim 15, wherein after the processor obtains the identity information from the input module, the processor obtains a third height information corresponding to the identity information from the storage device of the desk, the processor generates a fourth height information according to the first distance information of the body information, and the driving module adjusts a height of the desktop related to the base of the desk according to the fourth height information when a difference between the third information and the fourth information is larger than a specific value.

18. The desk of claim 17, wherein the processor stores the fourth height information into the storage device when the difference is larger than the specific value.

19. The desk of claim 13, wherein the sensing module senses a first distance information of the desktop of the desk related to a chair surface or a knee of a user and senses a second distance information of the desktop of the desk related to a shoulder of the user, and the sensing module generates the body information comprising the first distance information and the second distance information.

20. The desk of claim 19, wherein the processor generates a second height information according to the first distance information and the second distance information of the body information, and the driving module adjusts a height of the desktop related to the base of the desk according to the second height information.

21. The desk of claim 19, wherein after the processor obtains the identity information from the input module, the processor obtains a third height information corresponding to the identity information from the storage device of the desk, the processor generates a fourth height information according to the first distance information or the second distance information of the body information, and the driving module adjusts a height of the desktop related to the base of the desk according to the fourth height information when a difference between the third information and the fourth information is larger than a specific value.

22. The desk of claim 21, wherein the processor stores the fourth height information into the storage device when the difference is larger than the specific value.

23. The desk of claim 13, wherein after the processor obtains a mode information from the input module, the processor obtains an inclination information corresponding to the mode information from the storage device, and the driving module adjusts an inclination of the desktop related to the base of the desk according to the inclination information.

24. The desk of claim 23, wherein after the processor obtains the identity information and the mode information from the input module, the processor obtains the inclination information corresponding to the identity information and the mode information from the storage device, and the driving module adjusts the inclination of the desktop related to the base of the desk according to the identity information and the inclination information.
